(19) United States
(12) Patent Application Publication
(10) Pub. No.: US 2013/0233135 A1
(43) Pub. Date: Sep. 12, 2013

(54) INDUSTRIAL PRECISION SAFETY CUTTER

(71) Applicant: Cameron MacFarlane, Thornhill (CA)

(72) Inventor: Cameron MacFarlane, Thornhill (CA)

(21) Appl. No.: 13/416,505

(22) Filed: Mar. 9, 2012

(51) Int. Cl. B25G 3/00; B26D 3/00

(52) U.S. Cl. 83/13; 30/342

(57) ABSTRACT

An industrial precision safety cutter and a method of using the same, the industrial cutter having a cutter head. The cutter head has a reinforcing body, a first prong extending from the body, a second prong extending from the body, and a cutting edge extending from the body. The first prong has a rounded end. The cutting edge extends between the first and second prongs. The industrial cutter has an extendable length handle removably connected to the cutter head. The industrial cutter may be used in applications in the nuclear power industry.

### FIELD OF THE INVENTION

The present specification relates generally to the field of materials cutting devices. In particular, the present specification relates to industrial cutters for cutting materials in applications where safety is important, such as the nuclear industry.

### BACKGROUND OF THE INVENTION

In the nuclear industry, and in particular, in the field of maintenance and inspection of nuclear power plants, it is often necessary to deal with covered bundles of wires and fluid lines, heavy industrial storage and shipping bags, fire blanket material, industrial protective matting, manufacturers' packaging and other similar materials. A bundle of wiring, as shown in FIG. 1, consists of a series of wires, cables or fluid lines 14 all extending generally in the same direction and covered by a sleeve 12 such as a plastic shrink tube, electrical tape, duct tape or other such covering that holds them together. In order to conduct maintenance it may be necessary to cut open the cover of a bundle of wiring.

Because the inadvertent cutting of a wire, cable or fluid line can be catastrophic in, for example, the context of a nuclear power plant, maintenance personnel are limited by safety rules sharply limiting which cutters they can use to cut wire bundle covers and the like. For example, ordinary knives are forbidden, as are cutters known as X-Acto™ knives and Olfa™ adjustable cutters, where the blades can be extended up to about 10 cm. In limited cases, Olfa™ knives may be allowed when there is about 1.9 cm or less of exposed blade, biased with a spring to a closed or retracted position. Using this approved version of Olfa™ knives is difficult and awkward for maintenance personnel, because they have to constantly be forcing the knife to an open position while using it.

Another cutter that is sometimes permitted for use in this context is a seatbelt cutter. However, because of its configuration, it is very limited in how it can be used and what it can cut.

Furthermore, because of safety concerns relating to dirt, dust, bodily oils and the like, together with radiation concerns, maintenance personnel in nuclear plants and similar environments often wear at least two pairs of gloves, one on top of the other, while doing maintenance work, thus greatly reducing dexterity. This makes using the narrow range of permitted cutters all the more difficult.

Apart from the special safety concerns associated with contexts like nuclear power plants, traditional industrial materials cutters have a variety of flaws that are known to persons skilled in the art. For example, these cutters often have exposed blades shaped so as to create a risk of cutting or jabbing the user, or someone nearby, by mistake.

Some examples of cutting devices include the following:

U.S. Pat. No. 5,896,667 discloses a piercing-cutting device for plastic wrap removal from an object which includes a blade and handle.

U.S. Pat. No. 3,972,117 discloses a disposable blade device having two ends, one having a blunt point and a narrow stitch picker with a concaved edge portion between them and the other having two blunt projections joined by a concave sharpened area. The device is made from disposable razor blade stock or the like.

U.S. Pat. No. 2,764,814 discloses a ripping tool for tailoring and sewing.

U.S. Pat. No. 5,142,780 discloses a small, hand-held tool for removing the outer sheath of plastic material covering a bundle of individually insulated electrical conductors. The tool has a blade between a shoe and a metal shank.

U.S. Patent Publication No. 2002/0026711 discloses a plastic sheath cutting and slitting hand tool which includes a handle and a generally flat sheath engaging and slitting edge.

U.S. Pat. No. 6,182,364 discloses a safety stock carton knife including a handle and a blade projecting from the handle and having two lateral edges and an outer end.

U.S. Pat. No. 6,964,100 discloses a knife guard that selectively guards a tip of a blade of a knife while exposing at least a portion of a cutting edge of the blade which may be used by a user for field dressing an animal.

U.S. Pat. No. 3,572,189 discloses a tool for shaving and stripping the impregnated outer layer from the insulating jacket of an electrical conductor cable.

U.S. Pat. No. 2,637,904 discloses a knife or scalpel with a thin flat metal blade.

U.S. Pat. No. 1,474,107 discloses a safety razor blade holder.

U.S. Pat. No. 3,187,354 discloses a combination hunting tool, hatchet and axe with a knife-like gutting edge.

U.S. Pat. No. 3,621,899 discloses a convertible hand utensil with an interchangeable implement portion that is releasably connected to a handle portion.

U.S. Patent Publication No. 2003/0150117 discloses a utility knife with a cutting blade that is extendable to a desired length from the knife handle.

U.S. Pat. No. 3,100,935 discloses a tool for the ripping of seams and like purposes including a blade inset between the edge of a shank and an opposite blunt edge.

U.S. Patent Publication No. 2007/0245572 discloses a knife having a handle, a blade mounted on the handle and a blade guard.

U.S. Pat. No. 5,539,983 discloses a safety stock carton knife having an elongated handle having a blade projecting from the end of the handle having an outer sharp edge and the blade and outer edge of the blade converging to form a juncture with a blunt knob.

U.S. Pat. No. 4,198,751 discloses a skinning knife having a notched cutting edge which opens towards the knife handle and an enlargement on the one side of the notch which permits the user to slice the hide of an animal without cutting the underlying flesh.

U.S. Design Pat. No. D518,349 shows a utility knife for horse/bull riders which appears to show a cutting edge between two parts of a piece which extends from a handle.

U.S. Pat. No. 1,498,753 discloses a carcass opening device with a knife-shaped cutting blade having a sharp point and, near the handle, a blade arm at the end of which is fixed a ball.

U.S. Pat. No. 6,195,896 discloses a safety knife with a handle, a main blade mounted on the handle with a pointed end-part of the cutting edge of the blade projecting from the handle at an obtuse angle and a guard mounted on the handle to shield the projection portion of the blade.

### SUMMARY OF THE INVENTION

What is desired is a cutter that is versatile and has improved safety characteristics. The cutter preferably is strong and durable and allows for precise cutting. Such a cutter preferably meets the stringent safety requirements of the nuclear power industry or other industries in which safety is a primary concern.

According to one embodiment there is provided a precision safety cutter, comprising: a length-adjustable handle, and a cutter head, the handle and cutter head being configured to be detachably attachable to one-another; with the cutter head comprising a body, and a cutting edge on the body, wherein at least one portion of the cutting edge is recessed.

### BRIEF DESCRIPTION OF THE DRAWINGS

Reference will now be made, by way of example only, to preferred embodiments of the inventions and in which:

FIG. 1 is a section view of wires or cables within a sleeve or cover;

FIG. 2 is a perspective view of an embodiment of a cutter head of an industrial precision safety cutter having a threaded shank;

FIG. 3 is side view of an embodiment of a cutter head of an industrial precision safety cutter;

FIG. 4 is a side perspective view of the embodiment of a cutter head of the industrial precision safety cutter of FIG. 3 with a protective blade cover;

FIG. 5 is a side perspective view of an embodiment of a protective blade cover;

FIG. 6 is a side view of the embodiment of a cutter head of the industrial precision safety cutter of FIG. 4 with the embodiment of the protective blade cover of FIG. 5;

FIG. 7 is a side view of the embodiment of a cutter head of the industrial precision safety cutter of FIG. 3;

FIG. 8 is a side view of an embodiment of a handle of an industrial precision safety cutter;

FIG. 9 shows the cutter head carrying shaft carrying the cutter head and blade cover, separated from the grip; and

FIG. 10 shows the cutter head carrying shaft carrying the cutter head and blade cover, separated from the grip.

### DETAILED DESCRIPTION OF THE PREFERRED EMBODIMENTS

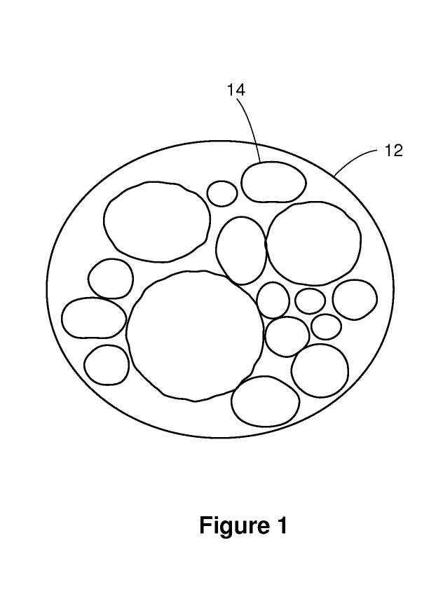

FIG. 1 shows a wire or cable bundle, including wires or cables 14, and bundle cover 12.

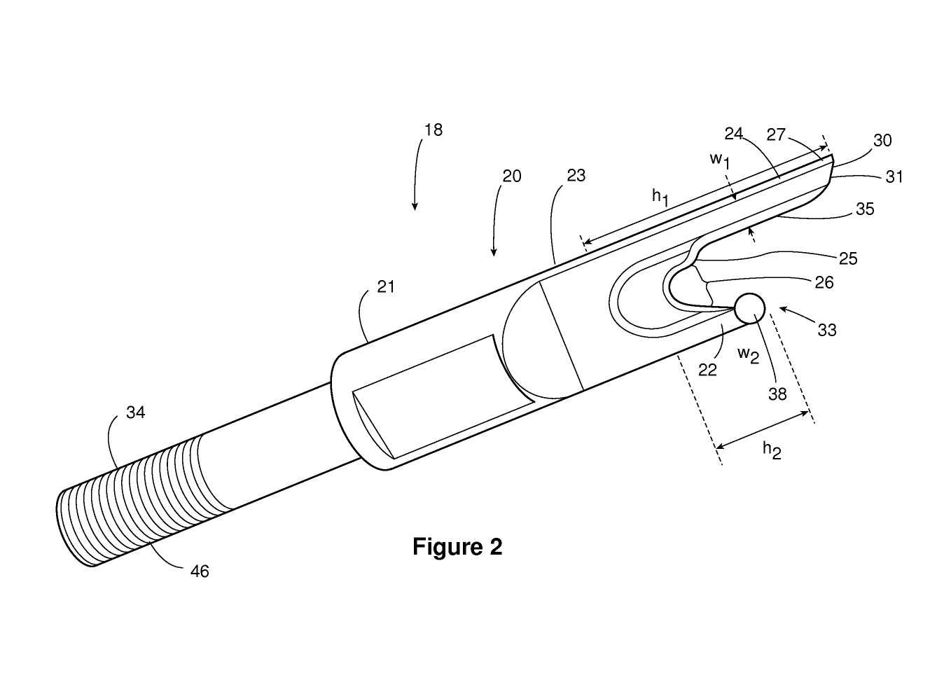

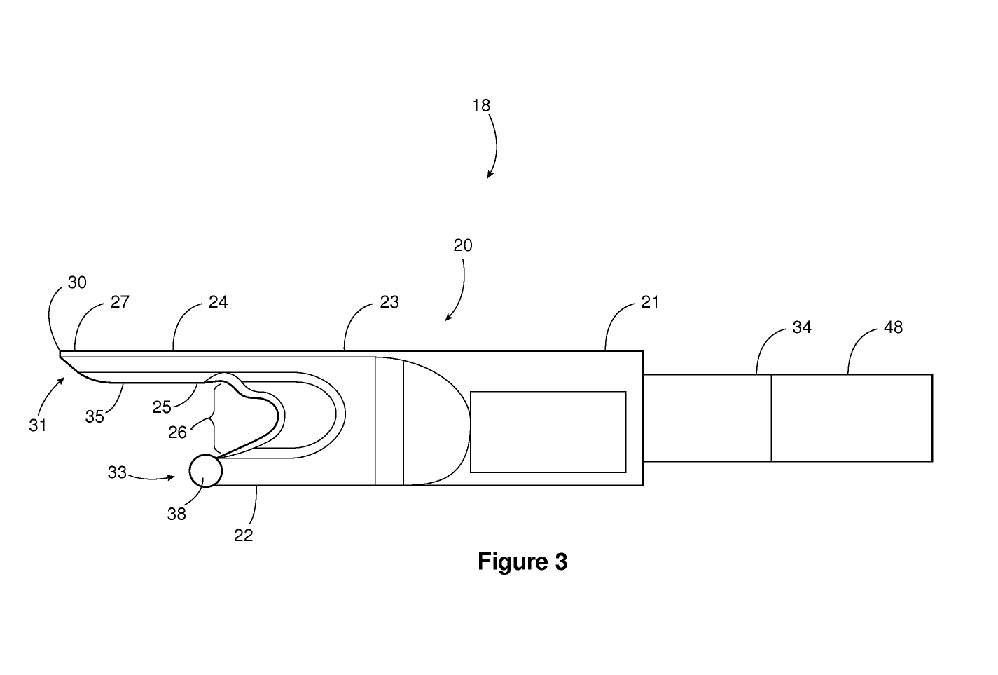

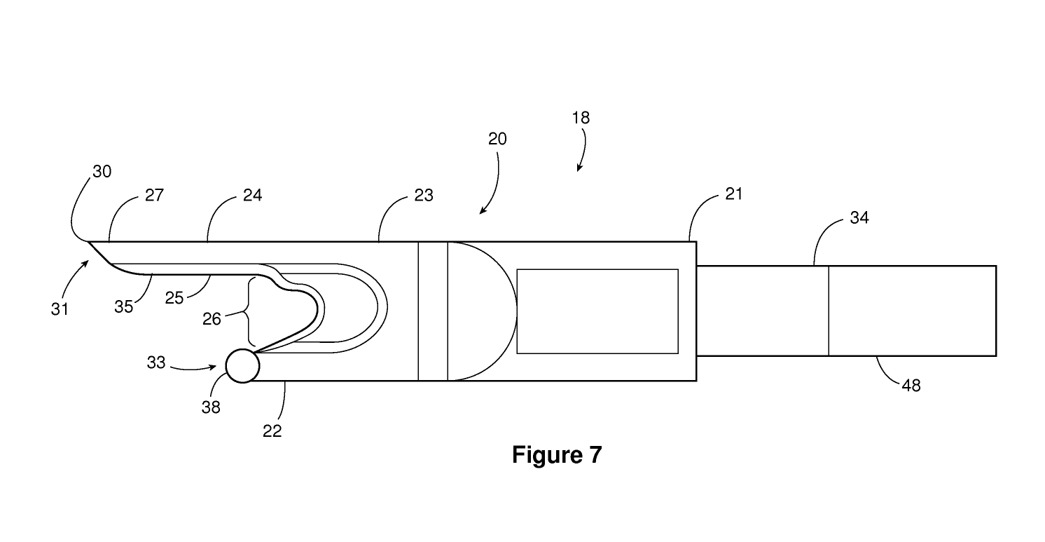

FIGS. 2-3 and 7 each show a cutter head 18 of a precision safety cutter 16. The cutter head 18 includes a body 20. The body 20 includes a reinforcing body portion 21 and a cutting edge carrying portion 23. Positioned on the cutting carrying portion 23 is a cutting edge 25.

As can be seen in FIG. 2-4, at least a portion of the cutting edge 25 is recessed. Preferably, this recessed portion 26 of cutting edge 25 is substantially in a U-shape. The body 20 preferably includes a first prong 24 and a second prong 22 depending from the cutting edge carrying portion 23. Most preferably, the first prong 24 is longer than the second prong 22, with the first prong 22 being configured as a puncture element 27. In particular, the first prong 24 is preferably configured to have puncture point 30, which can be used to puncture a material to be cut as desired.

Preferably, the cutter head further comprises a spacer 38, positioned on the body so as to space, during cutting, the cutting edge 25 from material not to be cut, while permitting the cutting edge 25 to cut material to be cut. Preferably, the spacer 38 comprises a bulbous element, most preferably in the form of a metallic ball, positioned adjacent to an end of cutting edge 25.

Thus, in the most preferred embodiment, the cutting edge carrying portion 23 of body 20 includes a first prong 24 having a first end 31, and a second prong 22 having a second end 33. The cutting edge 25 extends substantially in a U-shape between the first end 31 and the second end 33. The bulbous element is preferably positioned on the second prong 22 so as to space, during cutting, the cutting edge 25 from material not to be cut, while permitting the cutting edge 25 to cut material to be cut. Most preferably, the bulbous element 38 is positioned at second end 33.

It can now be appreciated how the precision safety cutter operates. If it is necessary to make a hole in a wire bundle cover or the like in order to begin cutting it, the puncture element 27, and in particular point 30, can be used to carefully puncture a hole in the material to be cut. The first prong can then be removed from the hole that was just punctured in the material to be cut. The second prong 22, carrying ball 38, can then be inserted into the hole that was punctured. The ball 38 functions to space the cutting edge 25 away from surrounding material not to be cut. Meanwhile, cutting edge 25 can be abutted against the material to be cut, and in response to the pressure, cutting edge 25 is advanced through the wire bundle cover or other material to be cut. Thus, the spacer 38 permits the cutting edge 25 to cut the wire bundle cover, or other material to be cut, while spacing from the cutting edge 25 from other material not to be cut, such as the wires, cables, fluid lines or other sensitive/fragile components within the bundle.

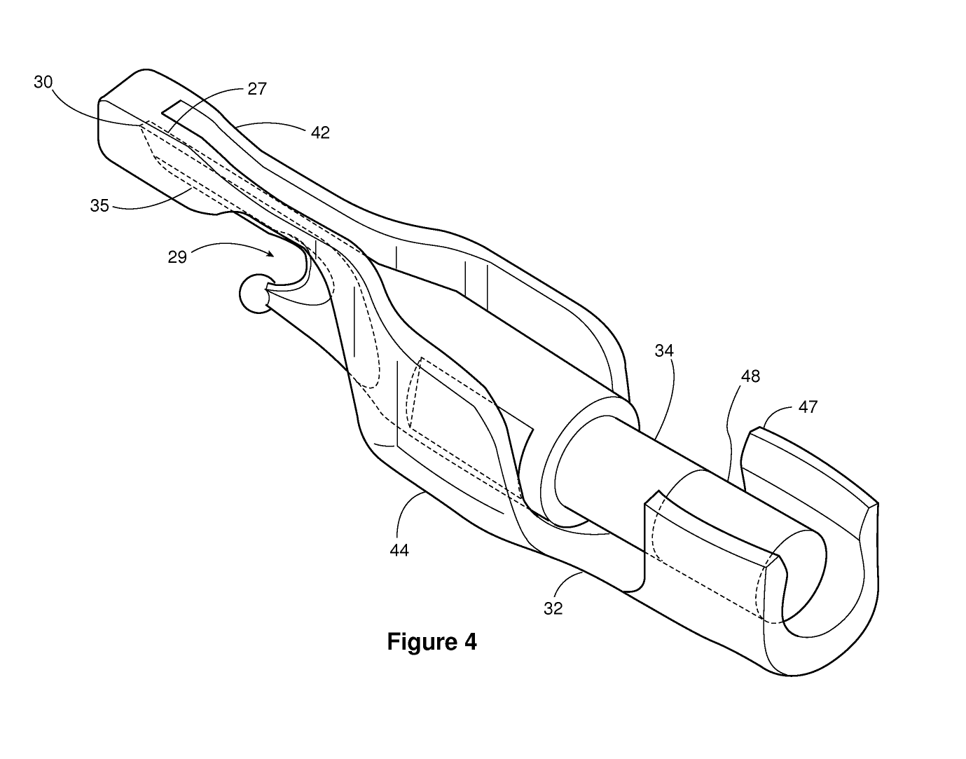

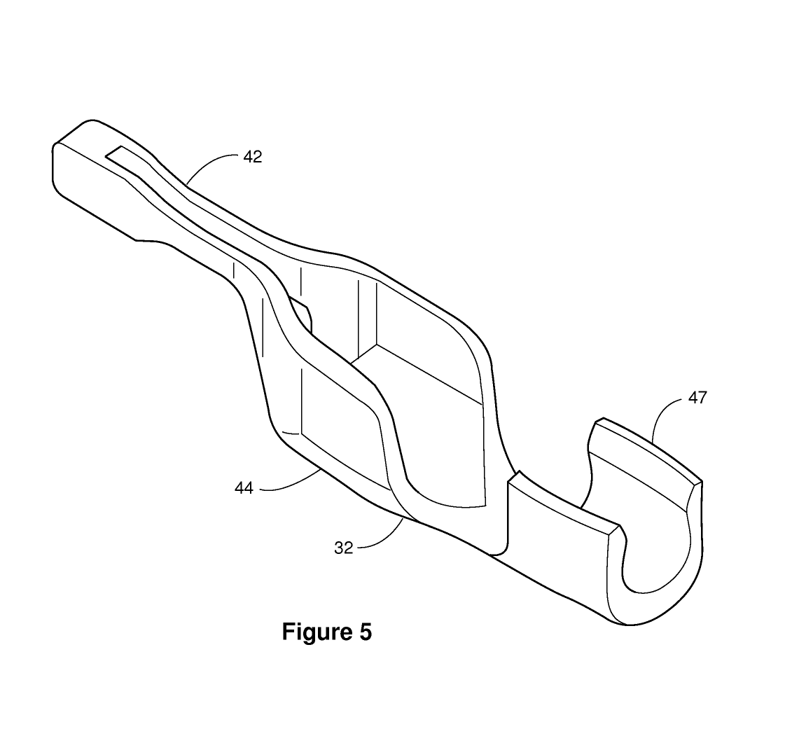

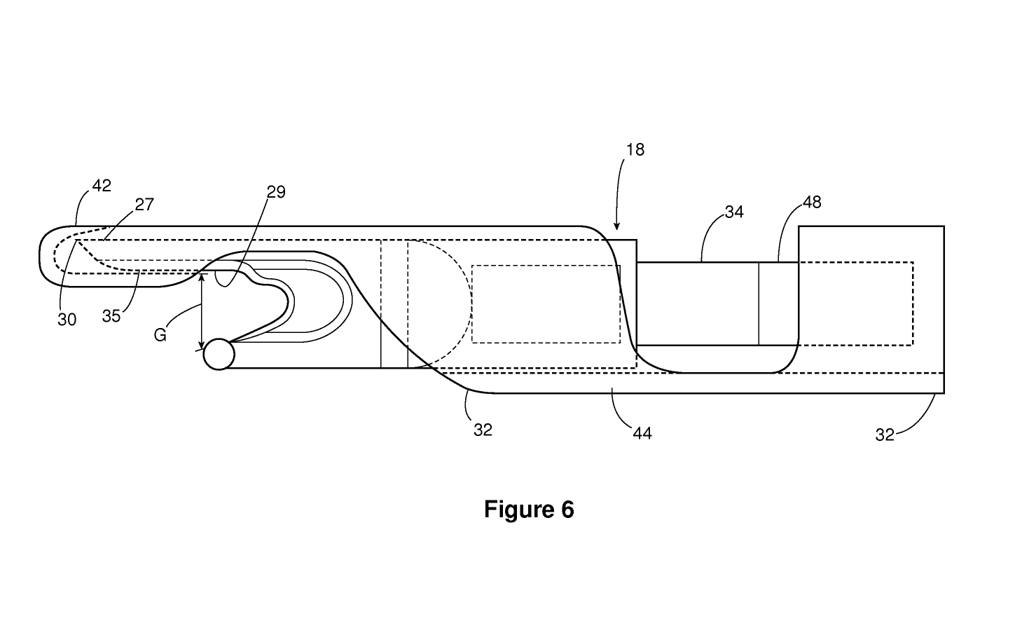

FIGS. 4 and 6 show cutter head 18 with a removal cutter cover in the form of a protective blade cover 32. FIG. 5 shows the cover 32 alone. Cover 32 is mountable on the cutter head 18, for example, as shown in FIG. 4. Cover 32 preferably extends over at least the first prong 24, and covers the pointed end 30. However, the cover 32 is preferably configured such that a portion 29 of cutting edge 25 is exposed for cutting, while the puncture element 27 is covered. Preferably, the exposed portion 29 of the cutting edge 25 is generally concave. It is also preferred that the cover 32 does not cover second prong 22 or the ball 38, so that the ball 38 can be used as a spacer during cutting, even when the cover 32 is mounted to the cutter.

Preferably, the cover 32 is mountable to the cutter head 18 in a snap fit, with a portion of the cover 32 snap fitting onto female portion 48 of cutter head carrying shaft 50. The cover 32 is shown in FIG. 5. It includes an extended pointed end cover 42 which extends over the first prong 24 and, in particular, puncture element 27 (including pointed end 30). In the embodiment shown in FIG. 5, cover 32 includes a section 44 covering the reinforcing portion 21 of body 20, as well as a rear cover 47 which extends around female portion 48. Preferably, the section 44 and reinforcing body portion 21 are configured such that section 44 snap fits to portion 21, holding cover 32 in place. However, other forms of snap fit are comprehended by the invention, as are other configurations of cover 32.

Although, in the preferred embodiment, cover 32 is mounted to cutter head 18 and shaft 50 by a snap fit, other means of mounting are comprehended by the invention. For example, the cover 32 could be mounted by a slide fit or an elastic connection. A magnetic mounting is also comprehended. What is most preferred is that the cover 32 covers the puncture element 27, while leaving exposed a (preferably concave) portion 29 of the cutting edge 25 for cutting.

In the preferred embodiment, the cover 32 covers not only the puncture element 27, but the portion 35 of the cutting edge 25 running along the first prong 24 adjacent to the puncture element 27.

As shown in FIG. 2, the second prong 22 has a width w₂ and a height h₂, and the first prong 24 has a width w₁ and a height h₁. In some embodiments, the height h₁ will be no greater than three times the width w₁, and the height h₂ will be no greater than three times the width w₂. That is, the first and second prongs each will have a height-to-width ratio that is no greater than three-to-one. It will be appreciated that if the prongs 22, 24 are too long and narrow, they may be at risk of breaking, particularly when cutting tough materials. The breaking of one of the prongs, or of the body 20 generally, when the cutter is in use can be particularly dangerous in certain industries, such as the nuclear reactor industry referred to above. It is therefore preferable that the body 20, including the prongs 22, 24, have a strong, heavy duty construction. As for the specific widths and heights, they may vary depending on the application for which the safety cutter is built.

The reinforcing portion 21 of body 20, as shown in FIG. 2, is preferably a solid potion of the cutter head 18 that has substantial additional thickness relative to the prongs 22, 24 and the cutting edge carrying portion 23. The added thickness of reinforcing portion 21 increases the strength and durability of the cutter head 18. In applications where it is not as important for cutter head 18 to have a heavy duty construction, the invention comprehends a cutter head 18 without an extra-thick reinforcing portion 21.

Referring now to FIG. 6, it will be appreciated that the cutter of the present invention is preferably configured to reduce the risk of a user's finger, or other body part, being cut or stabbed by the safety cutter. Thus, it is preferred that, when the cover 32 is mounted to the cutter head 18, the width or exposed portion 29 of cutting edge 25 (shown by reference character G, which stands for “Gap”) is less than the width of even a small finger of a user. Together with the fact that the cutting edge 25 is recessed, this preferred feature would further reduce the risk of a user being cut.

Preferably, the gap G is less than 1.3 cm wide, and most preferably, the gap G is between 2 mm and 10 mm wide. Reference character G corresponds to the width of the exposed portion 29 of the cutting edge when the cover 32 is mounted to the cutter head 18.

It will be appreciated that the cover 32 also enhances the safety of the cutter 16. Puncture element 30 is covered by cover 32, so the risk of a user being inadvertently jabbed or punctured is much reduced. The cover 32 can be mounted to the body 20 when the cutter 16 is in use, and removed only if it is necessary to puncture a material with puncture element 30. If such puncturing is not required, then cutting can be done with cover 32 in place, since a portion 29 cutting edge 25 is left exposed for cutting when cover 32 is mounted to the cutter 16.

The precision safety cutter may be made from any suitable material that provides the necessary strength. In many ordinary applications, steel, such as carbonizing hardened/case hardened steel, with or without nickel plating, would provide adequate strength and stiffness.

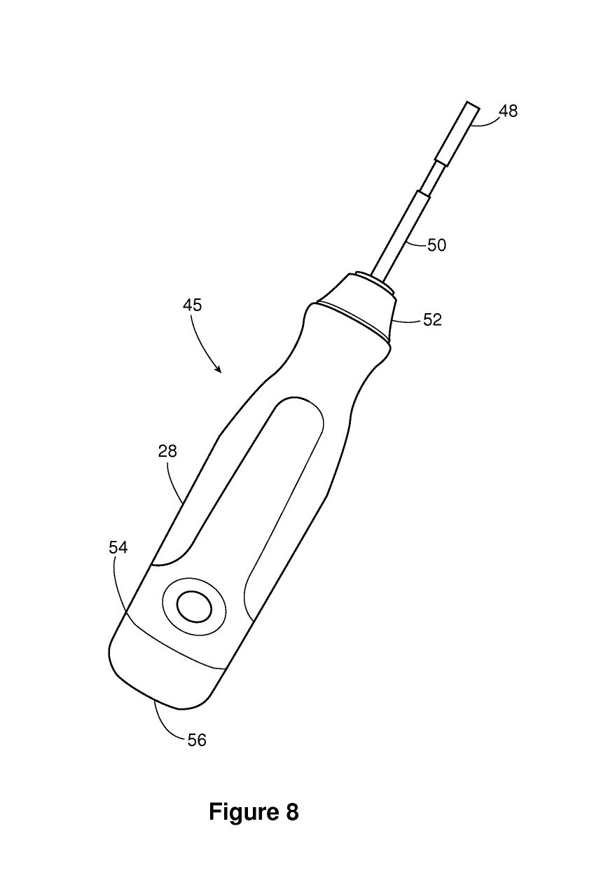

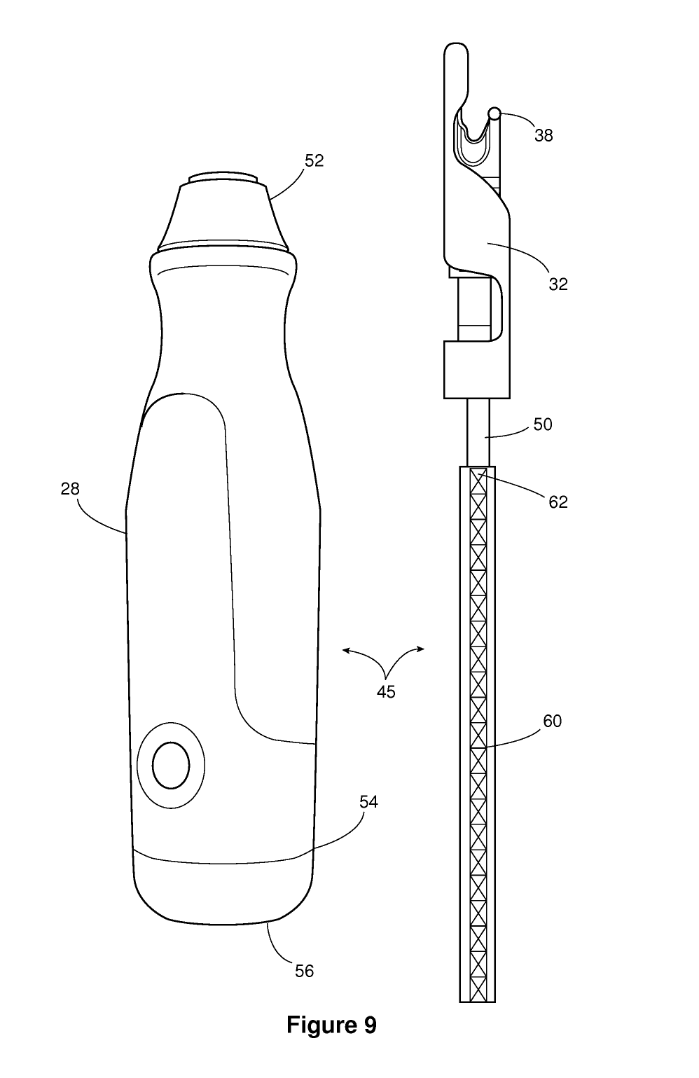

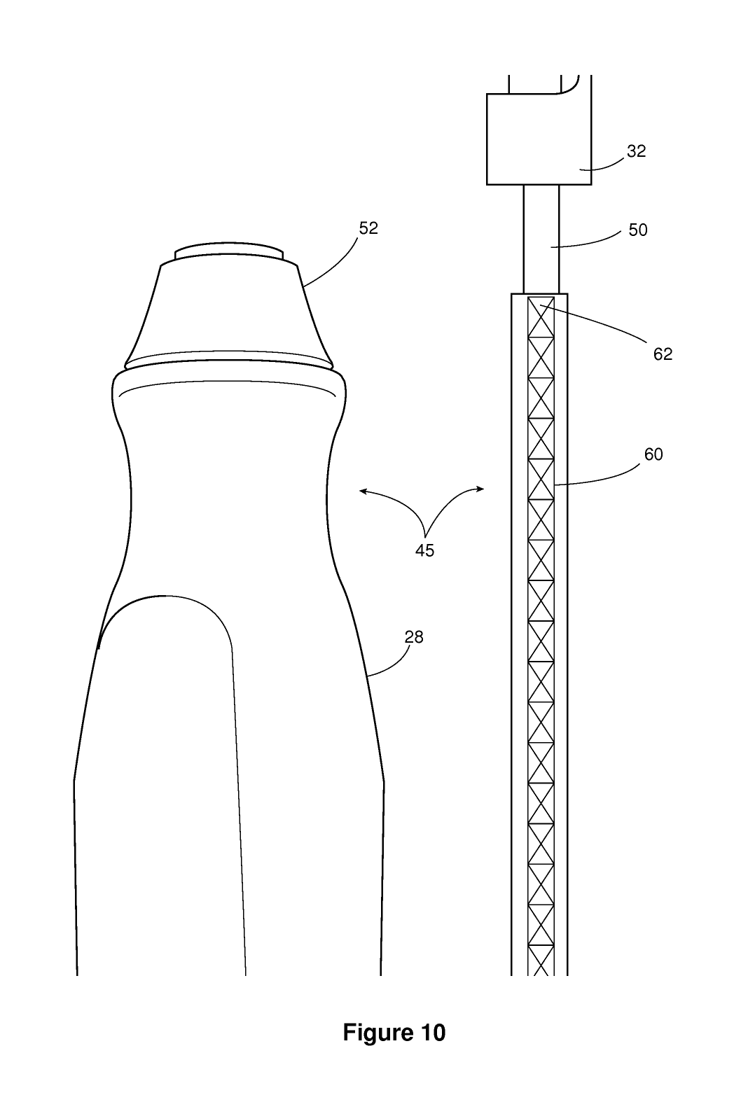

Preferably, the cutter further comprises a length-adjustable handle 45 shown in FIGS. 8, 9 and 10 most preferably including a screwdriver-type grip 28 that is formed for easy, effective and comfortable gripping of the handle, while at the same time providing for ease of manipulation for the user. Preferably, the handle 45 and cutter head 18 are detachably attachable from one another. Most preferably, the shank 34 of cutter head 18 comprises an externally threaded shaft 46, while the handle 45 comprises an internally threaded female portion 48 configured to receive the shaft 34. Preferably, portion 48 is positioned at the end of cutter head carrying shaft 50 distal from grip 28. In use, the handle 45 and cutter head 18 are attached by screwing the shank 34 into the female portion 48 of the shaft 50. The pieces are screwed together tightly to provide a stable safety cutter.

The length adjustable handle 45 preferably includes a cutter head carrying shaft 50 attached to and movable in and out of grip 28 to adjust the length of handle 45. In the most preferred embodiment, actuator 52 is mounted on shaft 50 and grip 28 in a spring-loaded mount. When in its outward unactuated position (away from grip 28), the actuator 52, because it is biased outward by a spring, holds a ball bearing (not shown) against a track means 60 running along shaft 50 to hold shaft 50 in place. The track means 60 comprises a line of indentations 62 for receiving the ball bearing. When actuator 52 is actuated (by pressing it toward grip 28 against the force of the spring loading) the ball bearing is liberated from the track means 60 and the shaft 50 can be pulled out of grip 28 to extend length of handle 45, or pushed in to contract the length. When actuator 52 is then released, the spring loading moves actuator 52 to a locking position where the ball bearing is forced against the indented track means, thus locking shaft 50 in place relative to grip 28.

Preferably, the grip 28 is hollow, with an opening 54, allowing spare cutter heads to be inserted into and contained in grip 28. The opening is preferably covered by a threaded plug cap 56, the cap 56 may be held in place by other means, such as a snap fit. Preferably, the grip 28 is made of a high friction plastic or rubber for ease of holding, and for comfort.

It will be appreciated that the preferred length-adjustable handle is easy to use. Actuator 52 can be depressed with the thumb and forefinger of a user's hand. The user's other hand can be used to grip cutter head carrying shaft 50 to extend or retract handle 45 by moving shaft 50 out of or into grip 28.

It will be appreciated that the invention comprehends other forms of length-adjustable handle besides the embodiment shown in FIG. 8. For example, the handle could comprise a grip with a shaft that folds or unfolds to adjust handle length. Other embodiments are also comprehended.

The particular features presented in the dependent claims can be combined with each other in other manners within the scope of the invention such that the invention should be recognized as also specifically directed to other embodiments having any other possible combination of the features of the dependent claims.

While the preferred embodiments have been described in detail, it will be appreciated that the invention comprehends other embodiments as well. For example, while less preferred, the cutter head may take a different form than the preferred form described in detail herein and still be comprehended by the invention.

1. A precision safety cutter, comprising:
a length-adjustable handle, and a cutter head, the handle and cutter head being configured to be detachably attachable to one-another;
the cutter head comprising:
a body;
a cutting edge on the body, wherein at least one portion of the cutting edge is recessed.

2. A precision safety cutter as claimed in claim 1, wherein the at least one portion of the cutting edge is U-shaped.

3. A precision safety cutter as claimed in claim 1, the cutter head further comprising a spacer positioned on the body so as to space, during cutting, the cutting edge from material not to be cut while permitting the cutting edge to cut material to be cut.

4. A precision safety cutter as claimed in claim 3, wherein the spacer is positioned adjacent to an end of the cutting edge.

5. A precision safety cutter as claimed in claim 4, wherein the spacer is comprises a bulbous element.

6. A precision safety cutter as claimed in claim 1, wherein the body and cutting edge are configured to form a puncture element adjacent an end of the cutting edge.

7. A precision safety cutter as claimed in claim 1, wherein the body includes a first prong having a first end and a second prong having a second end, the cutting edge extending substantially in a U-shape between the first end and the second end, the cutter further comprising a bulbous element positioned on the body so as to space, during cutting, the cutting edge from material not to be cut while permitting the cutting edge to cut material to be cut.

8. A precision safety cutter as claimed in claim 1, wherein the body includes a first prong and a second prong, the first prong being longer than the second prong and being configured as a puncture element;
the precision safety cutter further comprising a removable cutter cover mounted to the body, the cover, body, and cutting edge being configured such that a portion of the cutting edge is exposed for cutting and the puncture element is covered by the cover.

9. A precision safety cutter as claimed in claim 8, wherein the exposed portion of the cutting edge is generally concave.

10. A precision safety cutter as claimed in claim 9, wherein the exposed portion of the cutting edge is less than 1.3 centimetres wide, whereby the risk of a user's finger contacting the cutting edge is reduced.

11. A precision safety cutter as claimed in claim 10, wherein the exposed curved portion of the cutting edge is between 2 millimetres and 10 millimetres wide.

12. A precision safety cutter as claimed in claim 8, wherein the body and cover are configured such that the cover mounts to the body by a snap fit.

13. A precision safety cutter as claimed in claim 8, wherein the first prong has a length and a width, the length being less than or equal to three times the width.

14. A precision safety cutter as claimed in claim 8 wherein the cutter head and the handle are each threaded so as to be mateable by being screwed together.

15. A precision safety cutter as claimed in claim 14, wherein the cutter head includes an externally-threaded shaft and the handle includes an internally-threaded female portion configured to receive the shaft.

16. A precision safety cutter as claimed in claim 13, wherein the handle comprises a screwdriver-type grip.

17. A precision safety cutter as claimed in claim 16, wherein the handle further comprises a cutter head carrying shaft attached to and movable relative to the grip to adjust the length of the handle.

18. A method of cutting material, the method comprising the following steps:
a. providing the cutter as claimed in claim 7, wherein the bulbous element is positioned on the second prong and the first prong comprises a puncture element;
b. puncturing the material to make a hole in the material;
c. inserting the second prong and the bulbous element into the hole so that the cutting edge abuts the material while the bulbous element spaces the cutting edge from material not to be cut;
d. advancing the cutting edge through the material to cut the material.

19. A method of cutting material, the method comprising the steps of (1) using the cutter of claim 1 to cut material; (2) adjusting the length of the handle; and (3) repeating step (1).
